(19) United States
(12) Patent Application Publication
(10) Pub. No.: US 2008/0046276 A1
(43) Pub. Date: Feb. 21, 2008

(54) Consumer controlled behavior data mining service

(76) Inventors: Alistair Hamilton, Stony Brook, NY (US); Laura Hamilton, Stony Brook, NY (US); Vincent Luciano, Farmingville, NY (US)

Correspondence Address: Thomas A. O'Rourke;Bodner & O'Rourke, 425 Broadhollow Road, Melville, NY, 11747, US

(21) Appl. No.: 11/893,097

(22) Filed: Aug. 14, 2007

Related U.S. Application Data
(60) Provisional application No. 60/838,033, filed on Aug. 16, 2006.

(51) Int. Cl. G06Q 30/00

(52) U.S. Cl. 705/1

(57) ABSTRACT

Today's consumer information aggregation schemes are problematic from both a privacy standpoint and from the standpoint of providing complete, useful and actionable information about individual consumer behavior. For the most part, the consumer is offered little control of and little benefit from the existing information value chain. The invention provides a method for gaining access to significantly more complete information about the consumer in exchange for allowing the consumer to participate in the brokerage of that information as well as deriving direct benefit from the sale and use of that information.

This application claims priority on U.S. Provisional Patent Application Ser. No. 60/838,033 filed Aug. 15, 2006, the disclosures of which are incorporated herein by reference.

### OVERVIEW

Consumer Privacy concerns prevent people from willingly providing comprehensive data on themselves or their behavior. The business value of this data is high, as a research resource or as a potential customer listing. The proposed system here protects consumer privacy by giving consumers (users) control over the use of their data, in return for compensation from parties interested in their particular data. The user control motivates the sharing of more detailed, and more highly correlated data than was previously available.

### BACKGROUND

Consumer privacy is a major concern that has been heightened in the age of digital transaction systems. From credit card companies to grocery stores consumer behavior is tracked and used by companies to understand purchasing habits. The information is also used to provide feedback to suppliers and rewards or incentives to the consumers. Consumers are concerned that the information about their behavior could be used to invade their privacy or compromise their security. The value of aggregated consumer data is very high. There are companies that focus on gathering data from as many sources as possible and storing it in large databases. The larger and more diverse the data in the database, the more valuable it is for targeting promotional activities. Retailers and wholesalers use the data to select targets for mail order campaigns and catalogs. They in turn sell their mailing lists to others with similar target markets. The problem for the marketers is the quality of the data. How do they know the addresses are current and that the people they reach have an interest in the product? Refining this process would improve the yield or hit rate that these marketers get.

Having better data would enable sales materials and promotional material (coupons) to reach a tighter target—thus better driving the desired behavior. In the majority of cases, businesses do not know, on a person by person basis, how effective their campaign has been. They only know overall what percentage coupon redemption, or sales orders per catalogue were received. They often attempt to capture the result of a campaign by offering an incentive to revealing who you are at the time of purchase. Entering a ‘special promotion code’ while making the consumer feel special, is really to tell the seller that a certain person made a purchase from a certain promotional piece.

The loyalty card serves a similar purpose. It tells a store who is buying what. When cross-referenced with other data they have on a user such as age, gender etc., this is valuable data. Most retailers know it is valuable but seem to have failed to convert it to high business value. There is valuable competitive data back to the producers, and consumer goods companies, but a store can only tell what is happening in their store. They do not know what is happening in other stores by the same user.

Better data, if more complete, and if compiled in a highly central database would reach the point where it would be a resource for research. Producers could now in real time, who is purchasing their products, where, and in what patterns. They could measure the value of advertising, couponing, or price incentives.

Credit card and debit card companies have an advantage in that they can gather data across delivery channels . . . but they cannot capture what is on other cards, or what is paid in cash. The invention provides for the ability to aggregate across a plurality of such databases while enabling the consumer to retain detailed control of the use of that aggregated data. Furthermore, the invention provides mechanisms to allow the data to be aggregate even if a credit card company chooses not to participate in the data aggregation.

Newer services such as Upromise looks at user's loyalty card purchases, and credit cards and if they happen to have a sponsored brand, they pay the user a small fee that is added to an account. The invention provides for the ability to track purchases of additional transaction information beyond the specific card/item pairing in the Upromise scheme. Furthermore, the invention does not exclusively rely on the participation of the card company or the retailer to aggregate the data.

Nielsen is a tenured company that pays an incentive to a defined set of users to give them data on TV viewing, and groceries, in order to amass behavioral data on users. The invention provides information on specific consumers rather than the statistical inferences to the behavior within a set of demographics.

AeroPlan, in Canada, has a cross retailer-payment style independent tracking system in which a user presents a separate ID at the point of sale.

Products like Quicken and Microsoft Money allow a consumer to download detailed transactional logs of their credit card purchases and bank account transactions to their PC providing the consumer significant detail about their personal buying behavior. The invention provides for a consumer-controlled mechanism for the consumer to share that information into a global database, without requiring explicit participation on the part of the credit card companies or the retailers.

Products like Bank of America “My Portfolio” allow a consumer to create a portal of information about personal accounts that are held with companies that provide online access to their account information. In this manner a consumer can create a database of most of their personal transaction information in a single place. The underlying system logs in to each of the accounts listed by the consumer in the portal and collects the information that is in that specific account. The system then categorizes and presents the collected data to the user. The invention extends this concept by providing a set of mechanisms to offer the collected data to third parties in exchange for some benefit to the consumer.

A general differentiation between the invention and these existing schemes is that most of the existing schemes only capture transaction level detail. It is a goal of the invention to capture item detail below the transaction. Therefore, rather than knowing that the consumer spent $625.54 at Best Buy on a specific date, the invention captures that this included a TV, a DVD player and two DVDs.

### BRIEF DESCRIPTION OF THE DRAWINGS

FIG. 1 shows a representation of one embodiment of the present invention using a PDA.

FIG. 2 shows a block diagram of the preferred embodiment of the invention.

### DETAILED DESCRIPTION OF THE INVENTION

The Problem

The major weakness of all of the above and other existing solutions is threefold: First, there is no complete aggregation of consumer transaction data leaving those business that wish to better understand the individual customer without a useful resource. Second, what data is collected and available to companies is mostly outside the control of the consumer. And third, the current infrastructure leaves the consumer outside of the value chain—there is benefit exchanged between the information provider and the information user, but there is no direct benefit to the consumer.

The Solution

In order to create a system that is interconnected, and affords highly correlation data, the user would have to be given the control necessary to bring together the disparate data systems, as well as ‘private’ information. The system need to be flipped from one that primarily benefits the data collector, to one that primarily benefits the data provider. By creating a central entity that aggregates user provided data from a variety of sources, and then provides it back to the retailers, the seller can be satisfied with a better sales data, CPG's with better metrics, and the user with higher incentives. The customer base for the data would grow after the consumer data became more complete. Research or inquiries into healthcare, could aid in drug research, diet information, and many correlations could be made based on demographics, and these factors. Political research could be more detailed, and timely. Any researcher wanting to get at any segment of society could determine the parameters they are interested in and then either mine the existing data or go to the groups with specific questions.

Description of the System

There are three major components to the system: the user-database (UD), a plurality of data-provider-databases (DPD) and the consumer-information-server (CIS). The UD contains information about the user that is provided by the user. In a typical embodiment, the UD would be housed on servers that are closely tied to the CIS, but the UD could also be stored on the user's personal computer. The UD contains a plurality of information about the user such as name, age gender, height and weight. They can then add much more information based on their interests, lists of their possessions, home inventory, book lists, music libraries, or other collections.

The system would be established that would allow the user to connect existing data services to this one through the CIS internet service or account. Loyalty cards, credit cards, debit cards, bank accounts, frequent flyer cards, phone bills, cable bills, utilities, email, chat services. A preferred embodiment would operate similarly to the Bank of America “My Portfolio” referenced earlier. In an extended embodiment of the system, the user can be provided with a CIS loyalty card. The CIS card could be set to replace other loyalty cards by being accepted by specific retailers in lieu of their own loyalty card. The CIS would then allow the retailer to identify the user, as with a loyalty card. The retailer could also contract with the CIS to gain access to that user data. In this case the CIS can also be hosting the data for the retailer.

It is not envisioned that all providers of goods and services to the consumer will be willing to participate in the data collection. For example, a large retailer such as Walmart might opt to keep the data about their customer transactions secret. Even if a service cannot be connected digitally, due to technical or business reasons, the system will allow the user add this information to their UD profile through various means.
1. If a goods or services provider wishes to participate with only minimal impact on their IT systems, they can add machine readable versions of the transaction to the consumers receipt. The consumer can then use a scanner on their personal computer to add that receipt.
   a. If the consumer does not have a scanner, the consumer can collect and then send in these receipts to a third party scanning service that can add the information to the database.
2. If a goods or services provider does not wish to participate, the receipt provided to the consumer can be machine read using techniques such as OCR. The consumer can then use a scanner on their personal computer to add that receipt.
   a. If the consumer does not have a scanner, the consumer can collect and then send in these receipts to a third party scanning service that can add the information to the database.

A further embodiment of the invention can use preprinted and indexed envelopes delivered to the consumer by the service provider on a timed bases. The provider can send pre-addressed envelopes that the consumer can use to collect their receipts. The envelope can indicate the date for it to be mailed and then the next envelope can be used or the arrival of the new envelop can be used to trigger the mailing of the previous envelope.

Data can also be collected via pushed based queries such as surveys that can be used to fill out specific data areas desired. Furthermore, health related information, and behaviors, such as doctor and dentist visits, prescriptions, lab tests etc could also be included.

An underlying principal to encourage consumer participation is that the more information the users adds, the more they will be able to receive from inquiries as described below in the payment section.

The key unique element of this system is that the user gains control of their database, instead of the data being captured by other systems and taken out of the direct control of the consumer. The benefit is that the user keeps the data more up to date, more detailed, and more aggregated than any other system.

User Permissions for the Usage of the UD

The user decides and controls what information is available to be browsed, and what information they want to suppress. They can block their address, their zip code, or any location data. They can agree to be contacted under certain conditions, or demand to never be contacted. The permission system would from an architecture standpoint allow control of each individual piece of data collected about the consumer. In principal this would include the data collected from ALL sources. However in practice, commercial agreements might not allow for consumer control to extend to data collected by third parties (e.g., a credit report). Furthermore, given the large amount of transactional data collected, it is more than likely that the user would be unable or unwilling to control the access at the transaction level. Therefore, in a preferred embodiment access to the information in the UD and CIS would be controlled by a more generalized policy system wherein the user controls information based on categories of information provided and categories of buyers of the information.

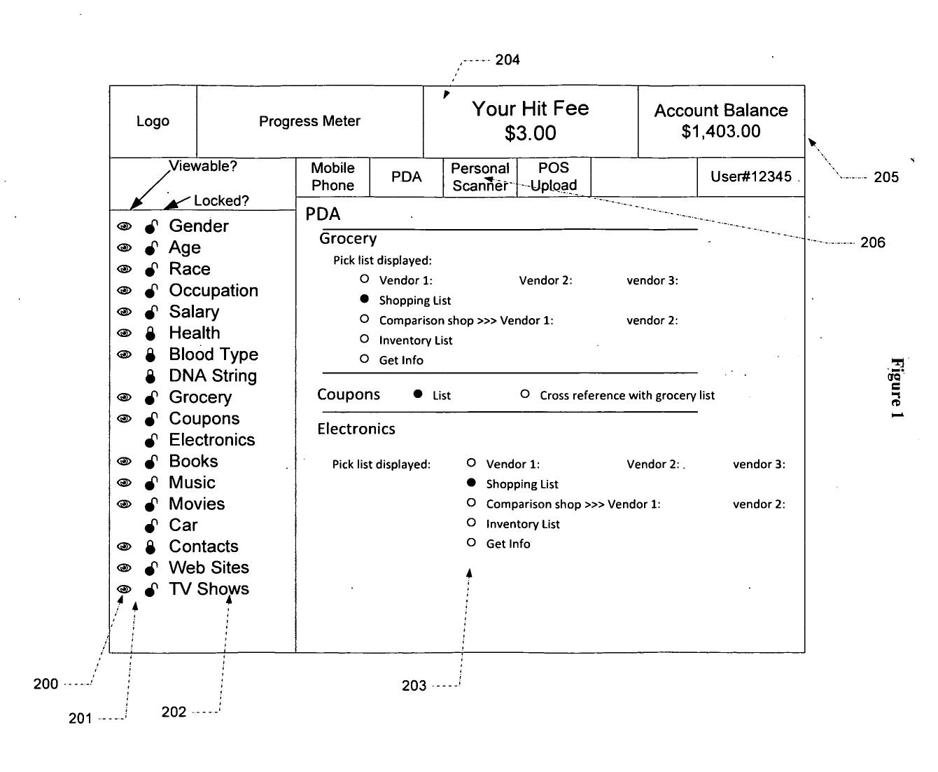

Referring to FIG. 1, the user portal for accessing the UD is shown. The organization of the portal is built around a list of data types 202 that can include transactional and demographic information about the consumer and their household. The user can control the access to their data by locking or unlocking each of these categories 201 and can see what data has been made viewable 200 by CIS users. The user can further control, access and input information form a series of data sources 206. Shown in the figure is the data collected by the users PDA 203. Summary information about the continued benefit of using the system is shown for both a per-inquiry value 204 and a total value acquired to date 205. The user controls the per inquiry value 204 by making more or less data visible.

A Typical Inquiry Into the CIS

An inquiry is made by a customer of the CIS requesting information about a consumer or groups of consumers with related characteristics. They provide search criteria that is relevant to their research or interests. The criteria offered would include choices from all of the categories of information covered on the CIS server.

If the information customer is looking for information that does not exist, a directed inquiry can be setup and sent directly to users who meet the demographic segment of interest. Charges for the inquiry could be based on a number of factors including but not limited to:
Number of hits or matches.
Number of data types searched
A contractual outsource of a segment of the user data (outsourced loyalty program)
Push based programs. (email or snail mail programs to members)
Included within a subscription fee
Unlimited access
Aggregated trend analysis

The Payment

The payment is triggered to a user when their data file is searched by an inquiry. The rate score is dependent on a number of factors:

Age of data—time scale available in account

Freshness of data—frequency of updates

Sensitivity of data—more personal access scores higher (set by system)

Amount/breadth of data—number of categories of data complete by user

Push/Pull—higher score for pushed out surveys

Currency—depending how the user chooses to be compensated (points, dollars, services*)

In a preferred embodiment a rate meter will be displayed in the users portal so that they can interactively see what the hit rate would be for their database.

Services

The CIS will be able to store actual data as both a reference to customers and a service to users. The musical collection store, for example, could be provide to allow access to music libraries, and audio files from any location. This will make the service more useful to the user, and allow for another data type to be aggregated, and referenced.

Another service example is a home inventory tool such as those found in Quicken, or Microsoft Money which allow an easy process for room by room inventory collection. The user would then choose what data, if any, was unlocked for viewing by inquiries.

Opportunity

The ability to cross reference behavior and activity from other companies would greatly improve the intelligence of the companies systems. A loyalty card system used at a grocery store, for example, can only track the purchases from that chain of stores. They do not know where their customers are going for other items purchased under other circumstances. Information on convenience or bulk purchases, for example, combined with the grocery data would be a more complete representation of shopping behavior, and is therefore more valuable.

Only the consumer can manage the capture of this breadth of information

If a consumer had control over the data that was tracked, aggregated and shared they could harness the value of information and receive compensation for the inspection of the data by other companies.

A consumer would then have an incentive to share meaningful data to many sources in order to maximize their rewards.

Security

Data security is key to the concept. Users must trust, in brand and technology that their data is secure. All steps that secure the data and reinforce its security to members is critical. The Invention:

The Consumer Behavior Service is an invention which enables . . . A data service with which the user can interact to add to, correct, or enhance information on themselves.

A data service in which a user can select and control what data gets shared, and with whom.

A data service which aggregates other data services, loyalty programs, or customer accounts from which individual information, buying habits, and interests, attitudes etc can be gleaned.

A data service that allows a user to process physical or paper based information (such as register tapes, credit card statements, etc) for uploading to the service. This action can be performed by the user or by the service.

To achieve the aforementioned, a data service which sends out data tags or codes to be applied to physical or paper based information to facilitate identification of the user or account to which the asset should be associated.

A data service that allows a user to upload personal inventories of possessions and collections. The user can furthermore use the collections as an interaction point (auctioning or selling items) (playing or sharing data)

A data service which gives points or credits to users based on the information they add and the amount of total information, the age of the information, the sensitivity of the information, and/or the method by which it was acquired. (or any of these in any combination)

A data service which dynamically adjusts the incentive rate paid to users based on criteria such as the amount, amount shared, type, completeness, and age of the data.

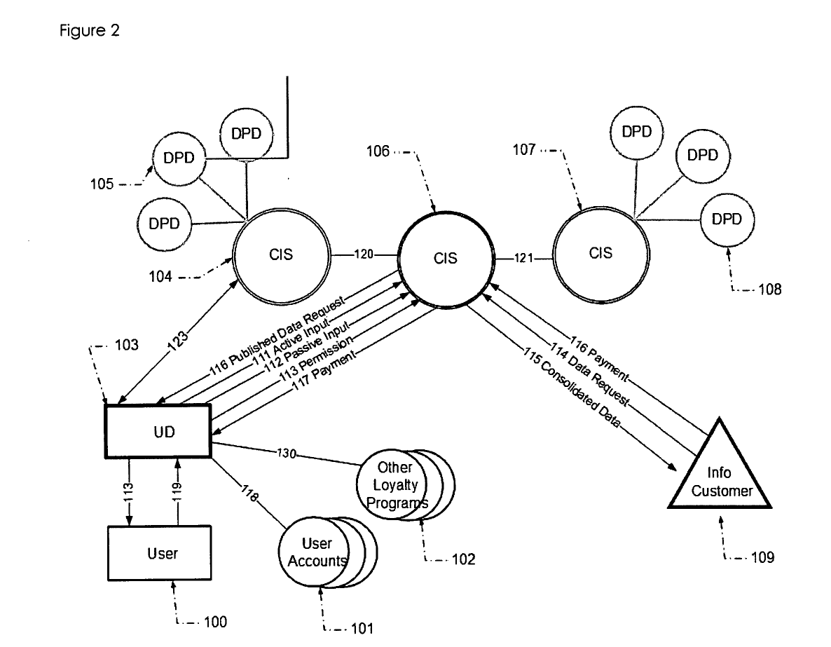

Referring to FIG. 2, a block diagram of the preferred embodiment is shown. The user 100 is provided with access to the UD 103 through an access device such as a personal computer, a PDA, or other such human interface device. The user provides input 119 to the UD through that includes personal data either entered directly by the user or scanned by a device such as a flat bed scanner connected to the access device. The data can be of various types including demographics and transactional information. In addition, the user can provide account information for third party accounts that they hold so that the UD can query those accounts 101 and gather summary and transactional date from said account systems by electronically connecting 118 to those systems. A plurality of account types can be access including loyalty programs 102 through an electronic connection 130 using the credential information provided by the user 100. The UD connects to one or more instances of the CIS 104, 106, 107 over electronic connections (e.g., 123). The electronic connection provides a plurality of transaction types, for example 111, 112, 113, 116, 117. Active inputs 111 include data that was proactively provided by the user 100. Passive inputs 112 include data that was provided by systems that the user enabled the UD to access 101, 102. The sources of information provided from the user 100 may be weighted, valued and believed differently by the buyer of the information, therefore the system keeps track of the source of the data. The system provides the ability to “push” a request for additional data 116 to the user based on requests from the information customer (IC) 119. This can either be proactive where the IC requests a novel set of data that is not in the database or general, where the IC requests information that is generally in the database but not in the specific customer record. A value is set by the IC so that the user 100 can determine if they wish to provide that information in exchange for the specified value. Extended embodiments could allow a bidding-style scheme where the user 100 can reply to the IC 109 with an alternative value proposal.

Since a main objective of the invention is to enable user 100 control of the data, a mechanism for the user to specify what data can be provided and at what value is built in to the UD and controls the ability of the CIS to provide that data to an IC 109. In the preferred embodiment, this permission control 113 is a hierarchical mechanism in that the user can say what information is globally available to ICs, and what information is available to specific classes of ICs and what information is only available on specific request. In extended embodiments, trusted partnerships can be established in that when I say IC#1 is able to have a specific set of data, IC#1 can then offer that information to a second IC in the user's belief that IC#1 will only offer that permission if they believe that IC#2 is interesting to the user and will use that information in a manner that would be to the user's benefit.

The CIS acts as a clearinghouse for the payments provided by the IC and places those payments into the UD via an electronic connection 117. A further function of the CIS 104, 106, 107 is to provide connectivity and aggregation from other DPDs 105, 108. The CIS connects the information about the user(s) with the appropriate UD. The figure shows a plurality of CISs 104, 106, 107 connected via electronic means 120, 121 so that the data can be synchronized. An alternative embodiment can use one or many CISs. The sense of the diagram should be taken as a distribution of CISs for multiple purposes such as computing performance where multiple systems are used for scaling purposes as well as commercially separate CISs where each CIS (or cluster of CISs for scaling purposes) is owned by separate commercial entities. In the second scenario, a revenue sharing scheme would be implemented to appropriately compensate all of the involved parties.

To obtain information about a user or a group of users the IC 109 makes a data request 114 to the CIS. The CIS then gathers the information from the appropriate UDs 103 through the mechanisms described previously and consolidates that data and returns it to the IC through an electronic or other means 115. A payment is provided to the CIS, a portion of which is retained by the CIS and a portion is provided to the UD.

What is claimed is:

1. A system for collecting consumer data from one or more consumers comprising:
a user database containing data collected from a consumer where the data obtained about said consumer is limited to data which said consumer permits said database to collect;
a consumer information server connected to said user database which receives a request from an information customer and processes said request to provide the information customer with data which said consumer permits the information customer to have access to and a means for processing a payment by said information customer to said consumer for said data.

2. The system according to claim 1 wherein the user data is housed on a plurality of servers.

3. The system according to claim 1 wherein the consumer can combine third party data concerning said consumer with information supplied by said consumer.

4. The system according to claim 1 wherein the database can combine third party data concerning said consumer with information supplied by said consumer.

5. The system according to claim 1 wherein the consumer information server permits a retailer to identify a consumer who is a participant in providing data to the database at the time of a purchase by said consumer.

6. The system according to claim 3 wherein the consumer manually inputs third party data concerning said consumer.

7. The system according to claim 4 wherein third parties provide data concerning said consumer, said information provided to the database being selected by said consumer.

8. The system according to claim 1 wherein said consumer can block selected data from an information customer.

9. The system according to claim 8 wherein data is sorted by category and said consumer controls access to each category of data.

10. The system according to claim 8 wherein the consumer can view what data is available to an information customer.

11. The system according to claim 1 wherein a consumer receives a payment when the consumer's database is searched by an information customer.

12. The system according to claim 1 wherein the amount of said payment is based on at least one or more of the following factors:
a) age of data;
b) freshness of data;
c) sensitivity of data; and
d) amount of data.

13. The system according to claim 12 wherein a rate meter is displayed at a consumer's portal showing hits from an information customer at the consumer's database.

14. The system according to claim 1 where an information customer provides a specific payment value to entice a consumer to provide desired information.

15. The system according to claim 14 wherein two or more information customers bid for the information.

16. The system according to claim 14 wherein a consumer can propose a payment value in response to an offer by an information consumer.

17. A method of obtaining consumer data comprising:
collecting data from a consumer, said consumer determining what data is collected;
providing said data to a database on a consumer information server;
receiving a request for data in said database from an information customer;
processing said request for data;
providing said data, which said consumer permits access to, to said information customer and;
providing payment to said consumer for said data.

18. The method according to claim 17 wherein an information customer requests information about one or more consumers.

19. The method according to claim 18, wherein said information customer provides search criteria.

20. The method according to claim 19 wherein if information on a subject does not exist, an inquiry is sent directly to consumers who meet a demographic segment of interest to provide such information.

21. The method according to claim 17 further comprising providing third party data concerning said consumer to said database.

22. The method according to claim 21 wherein said consumer provides said third party data to said database.

23. The method according to claim 21 wherein third parties provide said third party data to said database, said third party data being approved for inclusion by said consumer.

24. The method according to claim 17 further comprising providing specific payment value to entice a consumer to provide information sought by an information customer.

25. The method according to claim 24 wherein said consumer either accepts said offer, rejects said offer or proposes a counteroffer.
